(19) United States
(12) Patent Application Publication
(10) Pub. No.: US 2026/0358948 A1
(43) Pub. Date: Nov. 12, 2026

(54) DISPLAY APPARATUS, IN-VEHICLE SYSTEM, AND VEHICLE

(71) Applicant: TOYOTA JIDOSHA KABUSHIKI KAISHA, Toyota-shi (JP)

(72) Inventors: Seiichi TANAKA, Toyota-shi (JP); Akinori SHIN, Toyota-shi (JP); Junichi TODAKA, Seto-shi (JP); Kanako MATSUMOTO, Tokyo (JP); Sara YAMAFUJI, Miyoshi-shi (JP); Kazuyuki SHIGA, Nisshin-shi (JP); Yu YOKOYAMA, Ogaki-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/639,434

(22) Filed: Apr. 6, 2026

(30) Foreign Application Priority Data
May 8, 2025 (JP) 2025-078069

(51) Int. Cl. G06F 3/0488; B60K 35/10; B60K 35/22; B60K 35/25; B60K 35/26; B60K 35/65; B60K 35/81; G06F 3/01; G06F 3/0485; G06F 3/16

(52) U.S. Cl. CPC G06F 3/0488; B60K 35/10; B60K 35/22; B60K 35/25; B60K 35/26; B60K 35/654; B60K 35/81; G06F 3/016; G06F 3/0485; G06F 3/167; B60K 2360/1434; B60K 2360/1468

(57) ABSTRACT

A display unit of a display apparatus is configured to sequentially switch and display a first interface to an n^{th} interface in response to a predetermined touch operation performed by a user, and n is an integer equal to or greater than three. When a display is switched between the first interface and the n^{th} interface on the display unit, feedback is output to the user perceptually different from when the display is switched between interfaces other than between the first interface and the n^{th} interface.

### CROSS-REFERENCE TO RELATED APPLICATION

This application claims priority to Japanese Patent Application No. 2025-078069 filed on May 8, 2025. The disclosure of the above-identified application, including the specification, drawings, and claims, is incorporated by reference herein in its entirety.

### BACKGROUND

### 1. Technical Field

The disclosure relates to a display apparatus, an in-vehicle system, and a vehicle.

### 2. Description of Related Art

Japanese Unexamined Patent Application Publication No. 2023-152459 (JP 2023-152459 A) describes a technology relating to an automotive display. In the automotive display described in JP 2023-152459 A, a plurality of buttons is displayed in a carousel in a predetermined region on a screen.

Japanese Unexamined Patent Application Publication No. 2018-051365 (JP 2018-051365 A) describes a technology relating to a game apparatus. In the game apparatus described in JP 2018-051365 A, at least one selection target from among a plurality of selection targets with a set predetermined order is displayed on a display unit. Then, a switching unit switches the selection target to be displayed on the display unit in accordance with the predetermined order based on a first operation performed by a user. Furthermore, when the first or last selection target in the predetermined order is displayed on the display unit, the switching unit switches from the first selection target to the last selection target or from the last selection target to the first selection target based on a second operation performed by the user. Here, the first operation is a moving operation to move an operating point in a specific direction. The second operation is an operation of which the duration of operation on the first selection target or the last selection target is longer than a predetermined threshold.

Japanese Unexamined Patent Application Publication No. 2006-252366 (JP 2006-252366 A) describes a technology relating to a display apparatus. In the display apparatus described in JP 2006-252366 A, the display of a menu is sequentially and cyclically scrolled in response to an operation on an operator. In the display apparatus, during scrolling from the beginning of the menu to the end of the menu, and during scrolling from the end of the menu to the beginning of the menu, the scrolling is temporarily stopped for a longer time compared to when the menu is scrolled continuously.

### SUMMARY

The disclosure provides a display apparatus, an in-vehicle system, and a vehicle that improve convenience for a user in using the display apparatus in which a plurality of interfaces is sequentially switched and displayed on a display unit with a touch panel.

A first aspect of the disclosure relates to a display apparatus. The display apparatus includes a display unit with a touch panel. The display unit is configured to sequentially switch and display a first interface to an n^{th} interface in response to a predetermined touch operation performed by a user, and n is an integer equal to or greater than three. When a display is switched between the first interface and the n^{th} interface on the display unit, feedback perceptually different from when a display is switched between interfaces other than between the first interface and the n^{th} interface on the display unit is output to the user.

The display apparatus according to the first aspect of the disclosure may further include a sound output device. The feedback may be a sound output from the sound output device.

In the display apparatus according to the first aspect of the disclosure, a predetermined sound may be output from the sound output device when a display is switched between the first interface and the n^{th} interface on the display unit. A sound does not need to be output from the sound output device when a display is switched between interfaces other than between the first interface and the n^{th} interface on the display unit.

The display apparatus according to the first aspect of the disclosure may further include a haptic device. The feedback may be a haptic feedback output by the haptic device.

In the display apparatus according to the first aspect of the disclosure, a predetermined haptic feedback may be output by the haptic device when a display is switched between the first interface and the n^{th} interface on the display unit. A haptic feedback does not need to be output by the haptic device when a display is switched between interfaces other than between the first interface and the n^{th} interface on the display unit.

In the display apparatus according to the first aspect of the disclosure, the predetermined touch operation may be a scroll or swipe in a horizontal direction or a vertical direction.

A second aspect of the disclosure relates to an in-vehicle system. The in-vehicle system includes a display apparatus that includes a plurality of display units including at least a pair of display units, and an information processing apparatus configured to control the display apparatus. The pair of display units is respectively disposed at locations on both sides of a steering wheel while projecting toward a rear side of a vehicle beyond a meter unit disposed in front of a driver seat in a vehicle cabin and directly ahead of the steering wheel. Each of the pair of display units has a touch panel. The information processing apparatus includes a processor configured to on each of the pair of display units, sequentially switch and display first to n^{th} (n ≥ 3) interfaces in response to a predetermined touch operation performed by a user, and, when a display is switched between the first interface and the n^{th} interface on each of the pair of display units, output, to the user, feedback perceptually different from when a display is switched between interfaces other than between the first interface and the n^{th} interface on each of the pair of display units.

In the in-vehicle system according to the second aspect of the disclosure, the display apparatus may further include a sound output device. The processor may be configured to cause the sound output device to output a sound as the feedback.

In the in-vehicle system according to the second aspect of the disclosure, the processor may be configured to cause the sound output device to output a predetermined sound when a display is switched between the first interface and the n^{th} interface on each of the pair of display units. The processor may be configured not to cause the sound output device to output a sound when a display is switched between interfaces other than between the first interface and the n^{th} interface on each of the pair of display units.

In the in-vehicle system according to the second aspect of the disclosure, the display apparatus may further include a haptic device. The processor may be configured to cause the haptic device to output a haptic feedback as the feedback.

In the in-vehicle system according to the second aspect of the disclosure, the processor may be configured to cause the haptic device to output a predetermined haptic feedback when a display is switched between the first interface and the n^{th} interface on each of the pair of display units. The processor may be configured not to cause the haptic device to output a haptic feedback when a display is switched between interfaces other than between the first interface and the n^{th} interface on each of the pair of display units.

In the in-vehicle system according to the second aspect of this disclosure, the predetermined touch operation may be a scroll or swipe in a horizontal direction or a vertical direction.

A third aspect of the disclosure relates to a vehicle that includes the in-vehicle system according to the second aspect of the disclosure.

Other aspects include an information processing method executed by the information processing apparatus, a program for causing a computer to execute the information processing method, and a non-transitory computer-readable storage medium storing the program.

According to the aspects of the disclosure, convenience for a user in using a display apparatus in which a plurality of interfaces is sequentially switched and displayed on a display unit with a touch panel can be improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view that shows a state of a front part in a cabin of a vehicle according to an embodiment;

FIG. 2 is a view that shows the schematic configuration of a display apparatus and its surroundings;

FIG. 3 is a block diagram that schematically shows an example of the hardware configuration of a system mounted on the vehicle according to a first embodiment;

FIG. 4 is a block diagram that schematically shows an example of the functional configuration of an ECU;

FIG. 5 is a view that shows an example of a main screen displayed on an outer display;

FIG. 6A is a view that shows an example of an interface screen displayed on the outer display;

FIG. 6B is a view that shows an example of an interface screen displayed on the outer display;

FIG. 6C is a view that shows an example of an interface screen displayed on the outer display;

FIG. 6D is a view that shows an example of an interface screen displayed on the outer display;

FIG. 7 is a view that shows an example of a main screen displayed on an inner display;

FIG. 8A is a view that shows an example of an interface screen displayed on the inner display;

FIG. 8B is a view that shows an example of an interface screen displayed on the inner display;

FIG. 8C is a view that shows an example of an interface screen displayed on the inner display;

FIG. 8D is a view that shows an example of an interface screen displayed on the inner display;

FIG. 9 is a diagram that shows the order in which the interface screens are switched on the outer display;

FIG. 10 is a diagram that shows the order in which the interface screens are switched on the inner display;

FIG. 11 is a flowchart that shows the flow of display switching control for the interface screens according to a first embodiment;

FIG. 12 is a block diagram that schematically shows an example of the hardware configuration of a system mounted on a vehicle according to the second embodiment; and

FIG. 13 is a flowchart that shows the flow of display switching control for the interface screens according to the second embodiment.

### DETAILED DESCRIPTION OF EMBODIMENTS

There is known a display apparatus configured such that a plurality of interfaces can be switched and displayed on a single display. In such a display apparatus, when the display of an interface on the display is switched, a predetermined touch operation is performed by a user on the display. Then, in response to the predetermined touch operation performed by the user, the plurality of interfaces is sequentially switched in a preset order and displayed on the display. As a result, the user is able to selectively use the plurality of interfaces on the single display.

However, as the number of interfaces that can be displayed on the display increases, it becomes difficult for the user to determine whether all the interfaces that can be displayed in a cycle have already been displayed when the display of the interfaces is being sequentially switched by repeatedly performing the predetermined touch operation on the display. In other words, it can sometimes be difficult for the user to perceptually recognize whether the cycle of the plurality of interfaces that can be displayed on the display has already completed one round or is still ongoing. For this reason, the user may have difficulty in displaying a desired interface on the display. Therefore, there is room for improvement in convenience for a user in using a display apparatus in which a plurality of interfaces is sequentially switched and displayed on a display unit with a touch panel.

In contrast, one aspect of the disclosure provides a display apparatus that includes a display unit with a touch panel. On the display unit, first to n^{th} (n ≥ 3) interfaces are sequentially switched and displayed in response to a predetermined touch operation performed by a user; and, when a display is switched between the first interface and the n^{th} interface on the display unit, feedback perceptually different from when a display is switched between interfaces other than between the first interface and the n^{th} interface on the display unit is output to the user.

The display apparatus includes the display unit with the touch panel. Therefore, when the user performs a touch operation on the display unit, the operation is detected by the touch panel. On the display unit, the first to n^{th} interfaces are sequentially switched and displayed in response to the predetermined touch operation performed by the user. Here, n ≥ 3. In other words, in the display apparatus, n interfaces that are three or more interfaces can be switched and displayed on the display unit in a cycle.

Furthermore, the display apparatus is configured to be capable of outputting perceptible feedback to the user who has performed the predetermined touch operation on the display unit. Then, in the display apparatus, when the display of the interface on the display unit is switched in response to the predetermined touch operation performed by the user, feedback is output to the user. Here, feedback may be output to the user as, for example, a sound or a haptic feedback.

Here, as described above, the first to n^{th} interfaces are sequentially switched and displayed on the display unit in a cycle. At this time, when the display of the interface switches in a forward direction in response to the predetermined touch operation performed by the user, the first interface is displayed after the n^{th} interface. When the display of the interface switches in a reverse direction in response to the predetermined touch operation performed by the user, the n^{th} interface is displayed after the first interface. In other words, not only the display can be switched between sequentially adjacent interfaces among the first to n^{th} interfaces but also the display can be switched between the first interface and the n^{th} interface on the display unit.

In the display apparatus, when the display is switched between the first interface and the n^{th} interface on the display unit, feedback perceptually different from when the display is switched between interfaces other than between the first interface and the n^{th} interface on the display unit is output to the user. With this configuration, when the user repeatedly performs the predetermined touch operation to successively switch the display of the interface on the display unit and, as a result, the display switches between the first interface and the n^{th} interface, the user is able to perceptually recognize the switch. Therefore, the user is able to perceptually recognize whether the cycle of the n interfaces that can be displayed on the display has already completed one round or is still ongoing. This can contribute to enabling the user to display a desired interface on the display. Therefore, according to this disclosure, convenience for a user in using a display apparatus in which a plurality of interfaces is sequentially switched and displayed on a display unit with a touch panel can be improved.

Hereinafter, specific embodiments of the disclosure will be described with reference to the accompanying drawings. The dimensions, materials, and shapes of components described in the present embodiments, the arrangement of the components, and the like do not intend to limit the technical scope of the disclosure to them unless otherwise specified.

### First Embodiment

### Schematic Configuration of System

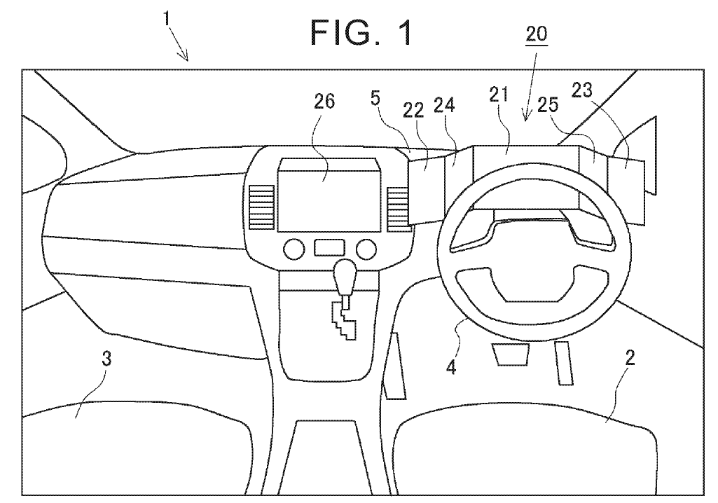

FIG. 1 is a view that shows a state of a front part in a cabin of a vehicle according to the present embodiment. A driver seat 2 and a front passenger seat 3 are provided in the cabin of the vehicle 1. The vehicle 1 of the present embodiment is a right-hand drive vehicle, and the driver seat 2 is provided on the right side in the traveling direction of the vehicle 1. A steering wheel 4 is disposed on the front side of the driver seat 2. The steering wheel 4 may be circular or may be U-shaped (so-called a non-circular steering wheel). The steering wheel 4 is connected to a steering system of the vehicle 1 via a steering column. The steering column is covered by a column cover. In the cabin of the vehicle 1, the front passenger seat 3 is provided on the left side of the driver seat 2 (on the left side in the traveling direction of the vehicle 1).

A display apparatus 20 is provided in the front region of the cabin of the vehicle 1. The display apparatus 20 includes a plurality of displays 21, 22, 23, 26. Specifically, the display apparatus 20 includes a meter display 21, an inner display 22, an outer display 23, and a center display 26. The meter display 21 is located in front of the driver seat 2 and directly ahead of the steering wheel 4 (substantially the center at the front part of the driver seat 2). The inner display 22 is located on the rear side and on the inner side of the meter display 21 relative to the vehicle 1. The outer display 23 is located on the rear side and on the outer side of the meter display 21 relative to the vehicle 1. The inner display 22 is connected to the meter display 21 via a connecting portion 24. The outer display 23 is connected to the meter display 21 via a connecting portion 25.

The center display 26 is located at an intermediate location between the driver seat 2 and the front passenger seat 3 in the front region of the vehicle cabin (substantially the center at the front part of the cabin). In other words, the center display 26 is provided on the side closer to the front passenger seat 3 than the meter display 21, the inner display 22, and the outer display 23 in the front region of the vehicle cabin.

Here, the outer side of the vehicle 1 refers to the side closer to the exterior of the vehicle 1 when viewed from the driver seat 2, that is, the door side of the driver seat 2. The inner side of the vehicle 1 refers to the side closer to the front passenger seat 3 when viewed from the driver seat 2, that is, the door side of the front passenger seat 3. For example, in the vehicle 1 in which the steering wheel 4 is provided on the right side of the vehicle 1, the outer side of the vehicle 1 refers to the right side of the vehicle 1, and the inner side of the vehicle 1 refers to the left side of the vehicle 1. For example, in the vehicle 1 in which the steering wheel 4 is provided on the left side of the vehicle 1, the outer side of the vehicle 1 refers to the left side of the vehicle 1, and the inner side of the vehicle 1 refers to the right side of the vehicle 1.

The meter display 21, the inner display 22, the outer display 23, and the center display 26 are all displays each of which has a touch panel. It is sufficient that at least each of the inner display 22 and the outer display 23 has a touch panel. The meter display 21, the inner display 22, and the outer display 23 may be formed by deforming a single touch screen or may be formed by combining individual touch screens.

A touch panel, such as a pressure-sensitive touch panel that detects the pressure applied by the user to the panel and a capacitive touch panel that detects changes in capacitance when the user presses the panel, can be adopted as the touch panel of each of the displays of the display apparatus 20. Each of the displays is, for example, a liquid crystal display (LCD) panel or an electro luminescence (EL) panel. In the following description, touching by the user means that the user touches the touch panel.

The center display 26 may display auxiliary information regarding driving (for example, navigation information) that is provided for the driver of the vehicle 1. The center display 26 may display information regarding entertainment, such as audio and television.

Here, a more detailed configuration of the meter display 21, inner display 22, and outer display 23 in the display apparatus 20 will be described with reference to FIG. 2. FIG. 2 is a view that shows the schematic configuration of the display apparatus 20 and its surroundings. The meter display 21 of the display apparatus 20 is fixed to an instrument panel 5. The meter display 21 is a horizontally-elongated display, while the inner display 22 and the outer display 23 are vertically-elongated displays. The meter display 21 is disposed such that the screen faces the rear of the vehicle 1 and is disposed parallel to the right and left direction (vehicle width direction) of the vehicle 1. The meter display 21 may be disposed so as to be tilted slightly upward.

One end of the connecting portion 24 is connected to the vehicle inner-side end of the meter display 21, and the inner display 22 is connected to the other end of the connecting portion 24. The inner display 22 is a display that extends from the vehicle inner-side end of the connecting portion 24 toward the rear and inner side of the vehicle 1. The angle that the inner display 22 makes with the meter display 21 is smaller than the angle that the connecting portion 24 makes with the meter display 21. The connecting portion 24 is connected to the meter display 21 and the inner display 22 while being curved. The connecting portion 24 has a curved surface that is concave toward the vehicle front side at the connection with the meter display 21, and has a curved surface that is convex toward the vehicle rear side at the connection with the inner display 22. The meter display 21 and/or the inner display 22 may have a curved surface.

One end of the connecting portion 25 is connected to the vehicle outer-side end of the meter display 21, and the outer display 23 is connected to the other end of the connecting portion 25. The outer display 23 is a display that extends from the vehicle outer-side end of the connecting portion 25 toward the rear and outer side of the vehicle 1. The angle that the outer display 23 makes with the meter display 21 is smaller than the angle that the connecting portion 25 makes with the meter display 21. The connecting portion 25 is connected to the meter display 21 and the outer display 23 while being curved. The connecting portion 25 has a curved surface that is concave toward the vehicle front side at the connection with the meter display 21, and has a curved surface that is convex toward the vehicle rear side at the connection with the outer display 23. The outer display 23 may have a curved surface.

The steering wheel 4 includes holding portions that are portions gripped by the driver. In the display apparatus 20, when the meter display 21, the inner display 22, the outer display 23, and the connecting portions 24, 25 have the shapes described above, the inner display 22 and the outer display 23 are respectively disposed near the holding portions of the steering wheel 4.

The inner display 22 and the outer display 23 are angled relative to the right and left direction of the steering wheel 4. Each of the inner display 22 and the outer display 23 is disposed so as to tilt toward the steering wheel 4. In other words, the inner display 22 is disposed so as to project toward the rear side of the vehicle 1 as it approaches the inner side of the vehicle 1, and the outer display 23 is disposed so as to project toward the rear side of the vehicle 1 as it approaches the outer side of the vehicle 1. In this way, each of the inner display 22 and the outer display 23 is disposed so as to face the driver.

The meter display 21 displays an interface that shows information used for driving the vehicle 1, such as the speed, engine rotation speed (when the vehicle 1 includes an engine), charge and discharge status (when the vehicle 1 includes a drive battery), travel distance, and status of an advanced driver-assistance system (ADAS) of the vehicle 1.

The outer display 23 displays interfaces (hereinafter, which may be referred to as “first interfaces”) regarding a plurality of first predetermined functions among a plurality of functions of the vehicle 1. Here, the first predetermined functions include functions related to control of the vehicle 1. The inner display 22 displays interfaces (hereinafter, which may be referred to as “second interfaces”) regarding a plurality of second predetermined functions different from the first predetermined functions among the functions of the vehicle 1. Here, the second predetermined functions include functions related to convenience for an occupant of the vehicle 1. Each of the first interfaces displayed on the outer display 23 and each of the second interfaces displayed on the inner display 22 include operating icons (for example, switch icons or button icons) that are operated by the driver of the vehicle 1. The details of the first predetermined functions, the second predetermined functions, the first interfaces, and the second interfaces will be described later.

As described above, the display apparatus 20 is configured such that the inner display 22 and the outer display 23 are paired in consideration of ease of operation for the driver. In the display apparatus 20, the size of the center display 26 is larger than the size of the inner display 22. The size of the center display 26 is larger than the size of the outer display 23. In the present embodiment, the meter display 21 is an example of the meter unit according to the disclosure. In the present embodiment, the inner display 22 and the outer display 23 are examples of the display unit according to the disclosure.

### Hardware Configuration

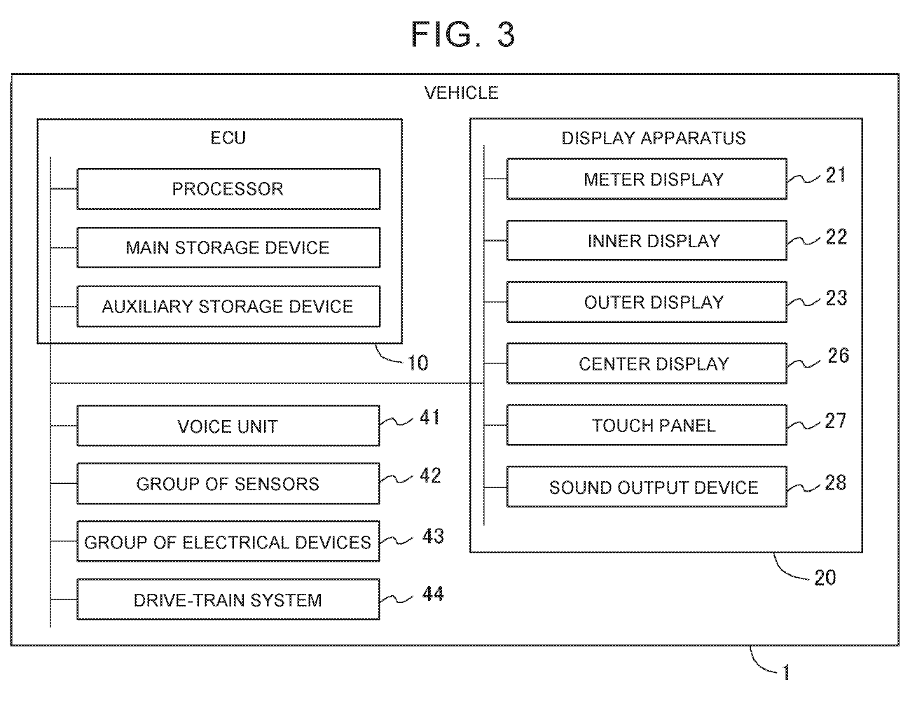

FIG. 3 is a block diagram that schematically shows an example of the hardware configuration of a system mounted on the vehicle according to the present embodiment. The system mounted on the vehicle 1 includes an ECU 10, the display apparatus 20, a voice unit 41, a group of sensors 42, a group of electrical devices 43, and a drive-train system 44.

The ECU 10 can be configured as a computer that includes a processor (such as a CPU and a GPU), a main storage device (such as a RAM and a ROM), and an auxiliary storage device (such as an EPROM, a hard disk drive, and a removable medium). An operating system (OS), various programs, various tables, and the like, are stored in the auxiliary storage device. Various functions (software modules) that match predetermined purposes as will be described later can be implemented by running the programs stored in the auxiliary storage device. One, some, or all of the functions may be implemented as hardware modules by a hardware circuit, such as an ASIC and an FPGA. The display apparatus 20, the voice unit 41, the group of sensors 42, the group of electrical devices 43, and the drive-train system 44 are connected to the ECU 10. The ECU 10 does not necessarily need to be made up of a single hardware component and may be made up of a plurality of computers. In the present embodiment, the ECU 10 is an example of the information processing apparatus according to the disclosure.

The display apparatus 20 includes the meter display 21, the inner display 22, the outer display 23, the center display 26, touch panels 27, and a sound output device 28. The touch panels 27 are units for detecting touch operations performed on the meter display 21, the inner display 22, the outer display 23, and the center display 26. The touch panels 27 are respectively disposed on the meter display 21, the inner display 22, the outer display 23, and the center display 26. Thus, each display is configured to be operable by touching. The meter display 21, the inner display 22, the outer display 23, the connecting portions 24, 25, and the touch panels 27 may be configured by deforming the shape of a single touch screen.

The sound output device 28 is a device for outputting sound (for example, electronic sound). The sound output device 28 may be configured to include, for example, a speaker or a buzzer. The sound output device 28 is disposed in each of the inner display 22 and the outer display 23. As will be described later, a plurality of interfaces is switched and displayed on each of the inner display 22 and the outer display 23. The sound output device 28 is a device for outputting a predetermined switching sound when the display of the interface is switched on the inner display 22 or the outer display 23. The details of control for outputting a predetermined switching sound from the sound output device 28 in association with switching of interfaces displayed on the inner display 22 or the outer display 23 will be described later.

The voice unit 41 is a unit that performs input and output of information by voice. The voice unit 41 may include, for example, a speaker and a microphone. The voice unit 41 is capable of capturing voice produced by an occupant of the vehicle 1. The voice unit 41 is capable of emitting voice to an occupant of the vehicle 1.

The group of sensors 42 is a collection of a plurality of sensors for acquiring sensor data used in driving the vehicle 1. The sensors may be the ones that acquire physical quantities or the ones that acquire image data and the like. The group of sensors 42 includes, for example, sensors that detect the states of the vehicle 1, sensors that detect the actions of the driver, and the like. Specifically, the group of sensors 42 may include a speed sensor, an acceleration sensor, an accelerator operation amount sensor, a brake sensor, a steering angle sensor, an engine rotation speed sensor, a yaw rate sensor, a turn signal switch sensor, a shift position sensor, a GPS sensor, an interior temperature sensor, an outside air temperature sensor, a distance measuring radar, an illuminance sensor, and the like.

The speed sensor detects the speed of the vehicle 1. The acceleration sensor detects the acceleration of the vehicle 1. The accelerator operation amount sensor detects the position of an accelerator pedal. The brake sensor detects the position of a brake pedal. The steering angle sensor detects the steering angle of the steering wheel 4. The engine rotation speed sensor detects the rotation speed of the engine. The yaw rate sensor detects the yaw rate of the vehicle 1. The turn signal switch sensor detects the status of the switch of a turn-signal light. The shift position sensor detects the shift position. The GPS sensor acquires the location information of the vehicle 1. The interior temperature sensor detects the interior temperature. The outside air temperature sensor detects the outside air temperature. The distance measuring radar measures the distance to an object. The illuminance sensor detects the brightness of an environment outside of the vehicle 1.

The group of electrical devices 43 is a collection of electrical devices provided in the vehicle 1. The group of electrical devices 43 includes vehicle control system devices, such as a headlight unit, a wiper actuator, a mirror actuator, and a seat actuator. The group of electrical devices 43 further includes in-vehicle apparatuses having functions other than vehicle control, such as a navigation system, a multimedia device, and an air conditioner.

The drive-train system 44 is a system made up of drive-train devices of the vehicle 1. The drive-train devices include, for example, the engine and/or a motor serving as a power source, a battery, and a transmission.

### Functional Configuration of ECU

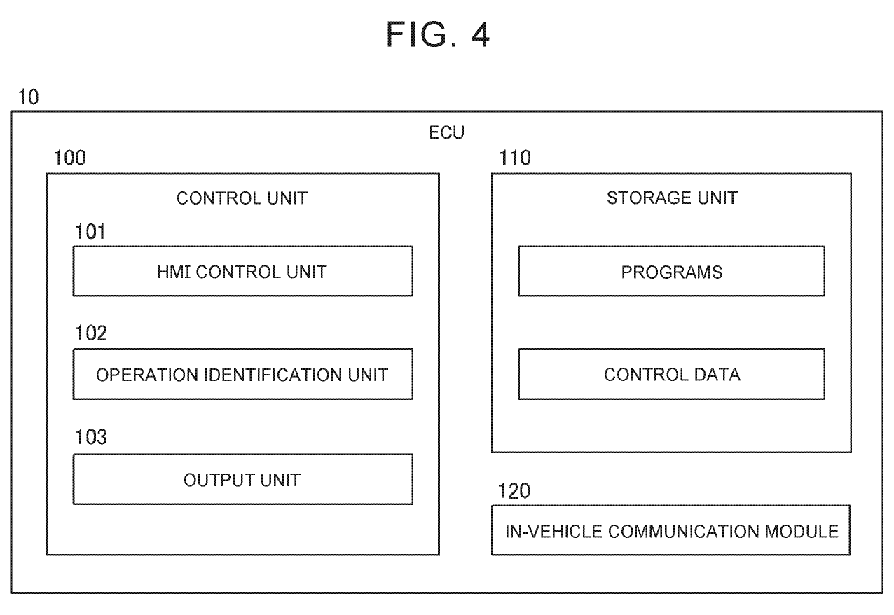

Here, the functional configuration of the ECU 10 will be described with reference to FIG. 4. FIG. 4 is a block diagram that schematically shows an example of the functional configuration of the ECU. The ECU 10 includes a control unit 100, a storage unit 110, and an in-vehicle communication module 120 as functional component elements. The control unit 100 is, for example, a functional component element provided by the processor running various programs stored in the auxiliary storage device. The display apparatus 20 receives a control instruction via any one of the touch panels 27 from the user that is an occupant of the vehicle 1. At this time, a signal corresponding to an input operation on any of the displays 21, 22, 23, 26 by the user is transmitted from a corresponding one of the touch panels 27 to the ECU 10. Then, in the ECU 10, the control unit 100 executes control of the display apparatus 20, the electrical devices included in the group of electrical devices 43, or the drive-train devices included in the drive-train system 44, in response to the input operation on any one of the displays by the user.

The control unit 100 includes a human machine interface (HMI) control unit 101, an operation identification unit 102, and an output unit 103 as software modules. The HMI control unit 101 generates interfaces regarding various functions of the vehicle 1. Furthermore, the HMI control unit 101 displays the generated interfaces respectively on the displays of the display apparatus 20. Each of the interfaces generated by the HMI control unit 101 and respectively displayed on the displays includes operating icons that can be operated by the user. The operating icons are icons that allow the driver to control various functions of the vehicle 1. The HMI control unit 101 receives control instructions input when the user operates the operating icons.

The operation identification unit 102 identifies the input operation of the user on any one of the displays based on a signal received from the corresponding touch panel 27 of the display apparatus 20. For example, the operation identification unit 102 identifies the location touched by the user on any one of the displays 21, 22, 23, 26 of the display apparatus 20. The operation identification unit 102 identifies the operation details of the input operation (such as flick, scroll, swipe, tap, pinch, double tap, long tap, and multi-tap) performed by the user on any one of the displays 21, 22, 23, 26 of the display apparatus 20.

The output unit 103 transmits a control signal corresponding to the control instruction received by the HMI control unit 101 or the input operation of the user, identified by the operation identification unit 102, to devices to be controlled (that is, any one of the display apparatus 20, the electrical devices included in the group of electrical devices 43, or the drive-train devices included in the drive-train system 44). In the devices to be controlled, the control signal transmitted by the output unit 103 is received, and control according to the control signal is executed.

The storage unit 110 is a functional component element that stores information. The storage unit 110 is configured to include the main storage device and the auxiliary storage device. The storage unit 110 stores various programs to be run by the control unit 100, and control data used to run the various programs.

The in-vehicle communication module 120 is a functional component element for connecting the ECU 10 to a vehicle network using a predetermined in-vehicle communication standard. A controller area network (CAN), a local interconnect network (LIN), or the like, can be illustrated as the predetermined in-vehicle communication standard. The ECU 10 communicates with various devices provided in the vehicle 1 via the in-vehicle communication module 120.

### Interfaces

Next, the interfaces displayed on the inner display 22 and outer display 23 of the display apparatus 20 will be described. As described above, the HMI control unit 101 displays a plurality of interfaces regarding various functions of the vehicle 1 respectively on the displays of the display apparatus 20. At this time, the HMI control unit 101 displays the first interface regarding the first predetermined function (a function related to control of the vehicle 1) on the outer display 23. The HMI control unit 101 also displays the second interface regarding the second predetermined function (a function related to convenience for an occupant of the vehicle 1) on the inner display 22.

In the display apparatus 20, the output destinations of the plurality of interfaces regarding various functions of the vehicle 1 are allocated according to the type of function as described above. As a result, the driver easily intuitively recognizes which one of the inner display 22 and the outer display 23 the interface that the driver desires to check or operate the display details is output to, by him or herself. The operating surface of the touch panel 27 of each of the inner display 22 and the outer display 23 is disposed near the steering wheel 4. As a result, when the driver attempts to execute various control by performing a touch operation on the display, the movement of the gaze and hand of the driver can be minimized.

One of the first interfaces is displayed on the outer display 23. One of the second interfaces is displayed on the inner display 22. Then, the first interface displayed on the outer display 23 and the second interface displayed on the inner display 22 are switched by the HMI control unit 101.

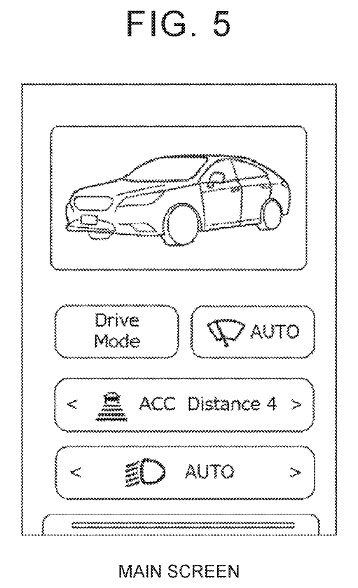

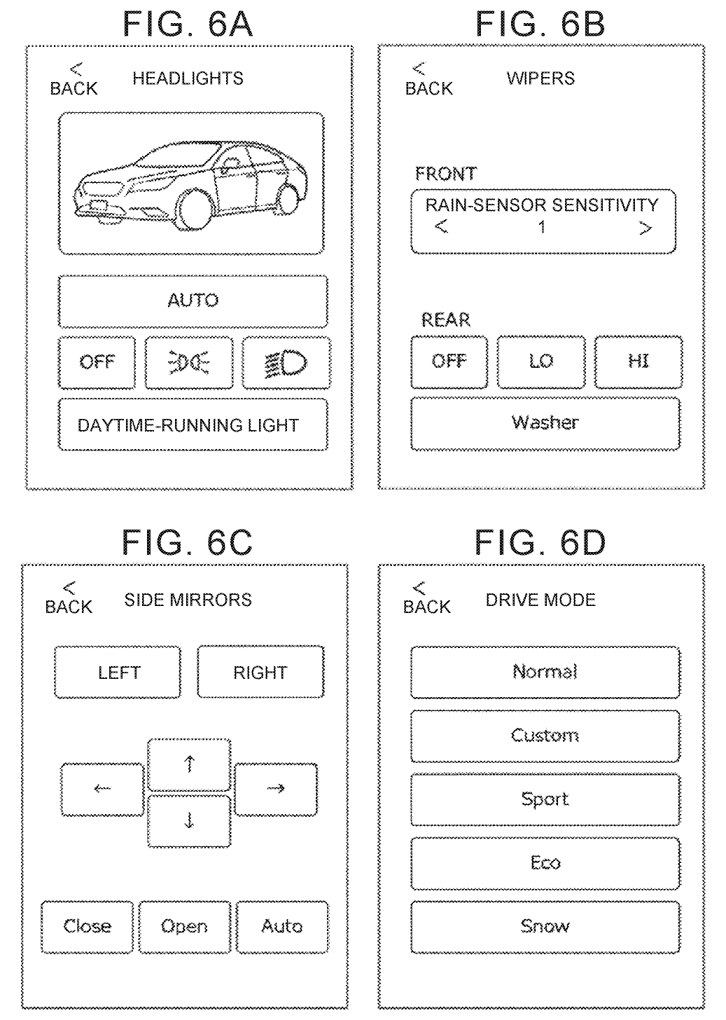

Here, the interface displayed on the outer display 23 will be described with reference to FIGS. 5,6A-6D, . FIGS. 5, and 6A-6D, are views that show examples of a plurality of interfaces (interface screens) displayed as the first interface on the outer display 23 by the HMI control unit 101. FIG. 5 shows a main screen displayed on the outer display 23. The main screen is an interface screen that is normally displayed on the outer display 23 while the vehicle 1 is being driven. The main screen displays operating icons regarding frequently used functions. The display details of the main screen can be customized by the user.

As shown in FIGS. 6A-6D , a headlight control screen (FIG. 6A), a wiper control screen (FIG. 6B), a mirror adjustment screen (FIG. 6C), and a drive mode settings screen (FIG. 6D) are displayed on the outer display 23 as the first interface.

### (A) Headlight Control Screen

The headlight control screen is an interface screen regarding a headlight control function. The headlight control screen includes operating icons for setting the status of the headlights of the vehicle 1 (automatic, on, off, small light, daytime running light, or the like). Then, based on the operations performed by the driver on the headlight control screen, the control unit 100 controls the headlight unit included in the group of electrical devices 43. The current status of the headlights is displayed on the headlight control screen.

### (B) Wiper Control Screen

The wiper control screen is an interface screen regarding a wiper control function. The wiper control screen includes operating icons for setting the operational statuses (stop, automatic operation, intermittent operation, continuous operation, or the like) of the wipers (a front wiper and a rear wiper) of the vehicle 1. Then, based on the operations performed by the driver on the wiper control screen, the control unit 100 controls wiper actuators included in the group of electrical devices 43. The current operational statuses of the front wiper and the rear wiper are displayed on the wiper control screen.

### (C) Mirror Adjustment Screen

The mirror adjustment screen is an interface screen regarding a mirror adjustment function. The mirror adjustment screen includes operating icons for adjusting the state (retracted or deployed state and angle) of the side mirrors of the vehicle 1. Then, based on the operations performed by the driver on the mirror adjustment screen, the control unit 100 controls the mirror actuators included in the group of electrical devices 43. The current state of the side mirrors is displayed on the mirror adjustment screen.

### (D) Drive Mode Settings Screen

The drive mode settings screen is an interface screen regarding a drive mode setting function. The drive mode settings screen includes operating icons for setting the drive mode of the vehicle 1. Then, based on the operations performed by the driver on the drive mode settings screen, the control unit 100 sets the drive mode.

All the above-described headlight control function, wiper control function, mirror adjustment function, and drive mode setting function are the first predetermined functions. However, the first predetermined functions are not limited to these functions. For example, a seat position adjustment function and an ADAS setting function are also the first predetermined functions. The seat position adjustment function enables the control unit 100 to adjust the positions and angles of the seats provided in the vehicle 1 by controlling the seat actuators. The ADAS setting function enables the control unit 100 to control the ADAS of the vehicle 1. Then, a seat position adjustment screen and an ADAS settings screen may be displayed on the outer display 23 as the first interfaces. The seat position adjustment screen is an interface screen regarding the seat position adjustment function. The ADAS settings screen is an interface screen regarding the ADAS setting function.

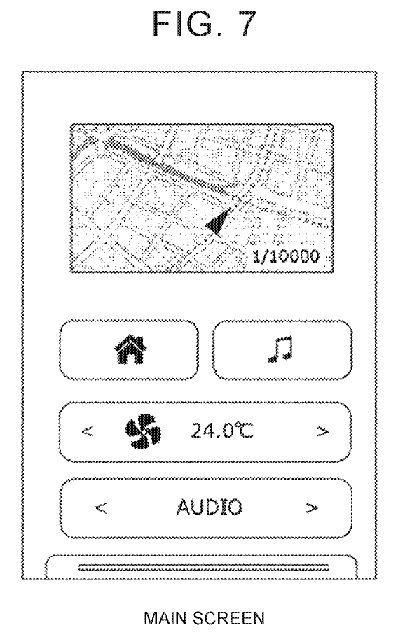

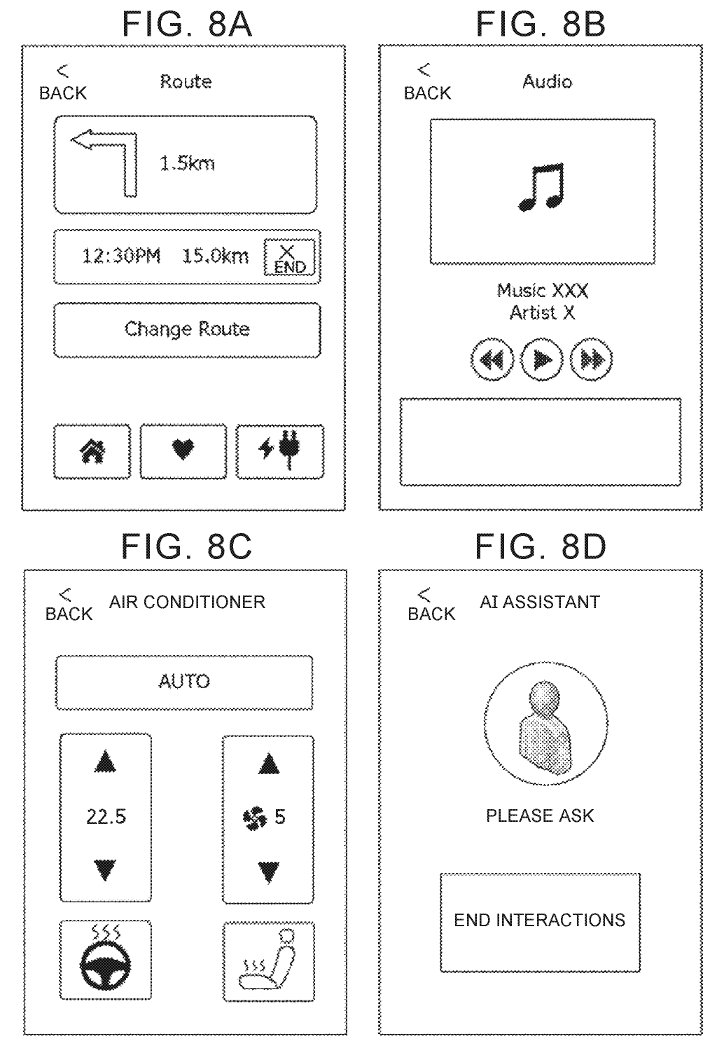

Next, the interface displayed on the inner display 22 will be described with reference to FIGS. 7, and 8A-8D . FIGS. 7 and 8A-8D, are views that show examples of a plurality of interfaces (interface screens) displayed as the second interface on the inner display 22 by the HMI control unit 101. FIG. 7 shows a main screen displayed on the inner display 22. The main screen is an interface screen that is normally displayed on the inner display 22 while the vehicle 1 is being driven. The main screen displays operating icons regarding frequently used functions. The display details of the main screen can be customized by the user.

As shown in FIGS. 8A-8D , a navigation screen (FIG. 8A), an audio screen (FIG. 8B), an air conditioner settings screen (FIG. 8C), and an AI assistant screen (FIG. 8D) are displayed on the inner display 22 as the second interfaces.

### (A) Navigation Screen

The navigation screen is an interface screen regarding a navigation function. Information regarding navigation, generated by the control unit 100, is displayed on the navigation screen. The navigation screen includes operating icons for destination setting, location registration, and the like.

### (B) Audio Screen

The audio screen is an interface screen regarding an audio function of the multimedia device. The audio screen includes operating icons for controlling the audio function of the multimedia device (such as playback of music). Then, based on the operations performed by the driver on the audio screen, the control unit 100 controls the multimedia device included in the group of electrical devices 43. Information regarding the music being generated is displayed on the audio screen.

### (C) Air Conditioner Settings Screen

The air conditioner settings screen is an interface screen regarding an air conditioner control function. The air conditioner settings screen includes operating icons for setting the operational status (such as temperature, airflow, and air conditioning function) of an air conditioner. Then, based on the operations performed by the driver on the air conditioner settings screen, the control unit 100 controls the air conditioner included in the group of electrical devices 43. The current operational status of the air conditioner is displayed on the air conditioner settings screen.

### (D) AI Assistant Screen

The AI assistant screen is an interface screen regarding an agent function. The AI assistant screen is a screen for interacting with a virtual agent (AI assistant) capable of natural-language dialogue. The AI assistant screen includes a character of a virtual agent. The user is able to obtain information by interacting with the character on the AI assistant screen. A natural-language dialogue service is provided by the control unit 100. The AI assistant screen includes operating icons for interacting with the AI assistant.

All the above-described navigation function, audio function, air conditioner control function, and agent function are the second predetermined functions. However, the second predetermined functions are not limited to these functions. For example, a telephone function is also the second predetermined function. The telephone function enables the control unit 100 to wirelessly connect to a user terminal in the vehicle 1 to achieve hands-free calling by controlling the wireless communication function of the multimedia device. Then, a call screen is displayed on the inner display 22 as the second interface. The call screen is an interface screen regarding the telephone function.

### Switching of Interface Screens

The user (driver of the vehicle 1) is able to switch the interface screen displayed on the inner display 22 by performing a predetermined touch operation as an input operation on the inner display 22. Similarly, the user is able to switch the interface screen displayed on the outer display 23 by performing a predetermined touch operation as an input operation on the outer display 23. Here, the predetermined touch operation may be, for example, a scroll or swipe in the horizontal direction (right and left direction). The predetermined touch operation may be a scroll or swipe in the vertical direction (up and down direction).

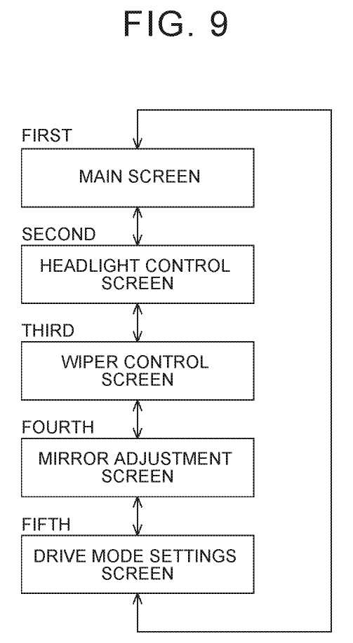

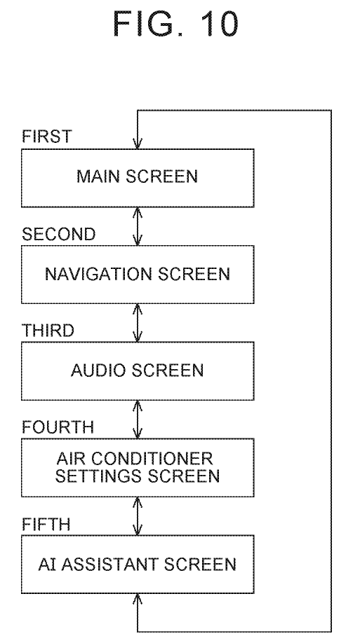

On each of the inner display 22 and the outer display 23, the plurality of interface screens is sequentially switched and displayed in response to a predetermined touch operation performed by the user. Here, the order in which the interface screens are switched on each of the inner display 22 and the outer display 23 will be described with reference to FIGS. 9 and 10 .

FIG. 9 is a diagram that shows the order in which the interface screens are switched on the outer display. As shown in FIG. 9, for the outer display 23, the main screen is set as the first interface, the headlight control screen is set as the second interface, the wiper control screen is set as the third interface, the mirror adjustment screen is set as the fourth interface, and the drive mode settings screen is set as the fifth interface.

FIG. 10 is a diagram that shows the order in which the interface screens are switched on the inner display. As shown in FIG. 10, for the inner display 22, the main screen is set as the first interface, the navigation screen is set as the second interface, the audio screen is set as the third interface, the air conditioner settings screen is set as the fourth interface, and the AI assistant screen is set as the fifth interface.

Then, on each of the inner display 22 and the outer display 23, when the interface screens are sequentially switched in a forward direction, the interface screens are switched in order from the first to the fifth, and then, after the fifth, back to the first. On each of the inner display 22 and the outer display 23, when the interface screens are sequentially switched in a reverse direction, the interface screens are switched in order from the fifth to the first, and then, after the first, back to the fifth. On each of the inner display 22 and the outer display 23, by switching the display of the interface screens in this way, the first to fifth interface screens can be displayed in a cycle.

The direction (the forward direction or the reverse direction) in which the interface screens are switched on each of the inner display 22 and the outer display 23 is a direction corresponding to a predetermined touch operation performed by the user. For example, in a case where the predetermined touch operation is a scroll or swipe in the horizontal direction, the interface screen may be switched in the forward direction when the user performs a scroll or swipe in the direction to the right-hand side, and the interface screen may be switched in the reverse direction when the user performs a scroll or swipe in the direction to the left-hand side. For example, in a case where the predetermined touch operation is a scroll or swipe in the vertical direction, the interface screen may be switched in the forward direction when the user performs a scroll or swipe in the downward direction, and the interface screen may be switched in the reverse direction when the user performs a scroll or swipe in the upward direction.

On each of the inner display 22 and the outer display 23, when the interface screen is switched, a predetermined switching sound is output from the sound output device 28 in synchronization with the switching timing. As a result, the user is able to recognize, not only visually but also auditorily, that the interface screen has switched in response to a predetermined touch operation performed by the user on the inner display 22 or the outer display 23.

Here, on each of the inner display 22 and the outer display 23, five types of interface screens can be switched and displayed in a cycle, as described above. For this reason, when the user repeatedly performs a predetermined touch operation on the inner display 22 or the outer display 23 to sequentially switch the display of the interface screen, it may become difficult for the user to perceptually recognize whether the cycle of the five types of interface screens that can be displayed on the display has already completed one round or is still ongoing. In such a case, the user may have difficulty in displaying a desired interface screen on the inner display 22 or the outer display 23.

In the display apparatus 20 according to the present embodiment, two types of sounds are used as predetermined switching sounds output from the sound output device 28. Specifically, on each of the inner display 22 and the outer display 23, when the display is switched between two interface screens that are sequentially adjacent among the first interface screen to the fifth interface screen, a first switching sound is output from the sound output device 28. In other words, when the display is switched between the first interface screen and the second interface screen, between the second interface screen and the third interface screen, between the third interface screen and the fourth interface screen, or between the fourth interface screen and the fifth interface screen, the first switching sound is output from the sound output device 28. On the other hand, on each of the inner display 22 and the outer display 23, when the display is switched between the first interface screen and the fifth interface screen, a second switching sound different from the first switching sound is output from the sound output device 28.

By using two types of sounds as predetermined switching sounds output from the sound output device 28, the user is able to perceptually (that is, auditorily) recognize the switch when the display is switched between the first interface and the fifth interface on each of the inner display 22 and the outer display 23. Therefore, it becomes easy for the user to perceptually recognize whether the cycle of the five types of interface screens that can be displayed on each display has already completed one round or is still ongoing. This can contribute to enabling the user to display a desired interface screen on the inner display 22 or the outer display 23.

### Control Flow

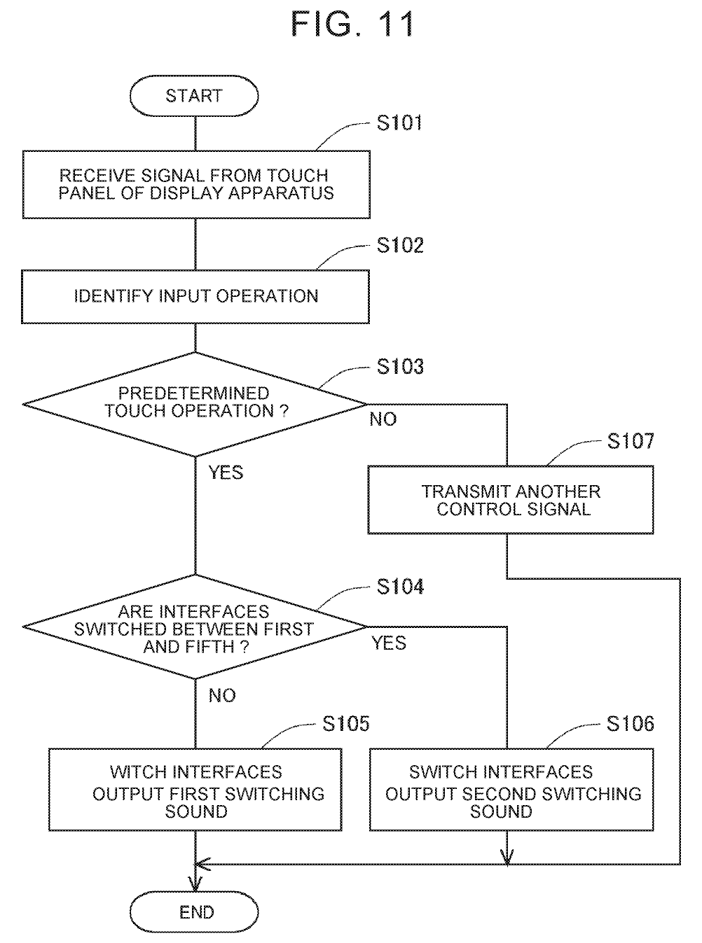

Hereinafter, the flow of the display switching control for the interface screens on each of the inner display 22 and the outer display 23 will be described with reference to FIG. 11. FIG. 11 is a flowchart that shows the flow of display switching control for the interface screens according to the present embodiment. This flow is executed by the control unit 100 of the ECU 10.

In this flow, initially, in S101, the control unit 100 receives a signal corresponding to an input operation by the user, transmitted from any one of the touch panels 27 of the display apparatus 20. Subsequently, in S102, the control unit 100 identifies the input operation by the user on any one of the displays 21, 22, 23, 26 of the display apparatus 20 based on the signal received in S101. As described above, the process of S102 is executed by the operation identification unit 102.

Subsequently, in S103, the control unit 100 determines whether the input operation by the user, identified in S102, is a predetermined touch operation on the inner display 22 or the outer display 23. When the determination is negative in S103, control requested by the user via the display apparatus 20 can be determined as control other than the display switching control for the interface screens. In this case, subsequently, the process of S107 is executed. In S107, the control unit 100 transmits a control signal for executing control (other than display switching control for the interface screens) according to the details of control instruction received from the user by the display apparatus 20 to the devices to which the control instruction is transmitted. After that, the execution of this flow is once ended.

On the other hand, when the determination is affirmative in S103, the control instruction received by the display apparatus 20 from the user can be determined as a display switching instruction for the interface screens on the inner display 22 or the outer display 23. In this case, subsequently, the process of S104 is executed. In S104, the control unit 100 determines whether the display switching instruction for the interface screens, received from the user, is an instruction to switch the display between the first interface screen and the fifth interface screen.

At this time, there may be cases where a predetermined touch operation for switching the interface screen in the forward direction is detected by the touch panel 27 in a state where the fifth interface screen is displayed on the inner display 22 or the outer display 23. In this case, the control unit 100 can determine that the display switching instruction received from the user by the display apparatus 20 is an instruction to switch the display from the fifth interface screen to the first interface screen. There may be cases where a predetermined touch operation for switching the interface screen in the reverse direction is detected by the touch panel 27 in a state where the first interface screen is displayed on the inner display 22 or the outer display 23. In this case, the control unit 100 can determine that the display switching instruction received from the user is an instruction to switch the display from the first interface screen to the fifth interface screen.

When the determination is negative in S104, that is, when the display switching instruction received from the user is an instruction to switch the display between two interface screens that are sequentially adjacent among the first interface screen to the fifth interface screen, the process of S105 is subsequently executed. In S105, the control unit 100 transmits, to the display apparatus 20, a control signal for switching the display of the interface screen on the display where a predetermined touch operation has been performed between the inner display 22 and the outer display 23. As a result, on the inner display 22 or the outer display 23, the display is switched between two interface screens that are sequentially adjacent among the first interface screen to the fifth interface screen.

Furthermore, in S105, the control unit 100 also transmits, to the display apparatus 20, a control signal for causing the sound output device 28, disposed on the display where a predetermined touch operation has been performed between the inner display 22 and the outer display 23, to output the first switching sound together with the control signal for switching the display of the interface screen. As a result, on the inner display 22 or the outer display 23, the first switching sound is output from the sound output device 28 at the timing when the display of the interface screen is switched. After that, the execution of this flow is once ended.

On the other hand, when the determination is affirmative in S104, the process of S106 is subsequently executed. In S106 as well, the control unit 100 transmits, to the display apparatus 20, a control signal for switching the display of the interface screen on the display where a predetermined touch operation has been performed between the inner display 22 and the outer display 23. However, in this case, on the inner display 22 or the outer display 23, the display is switched between the first interface screen and the fifth interface screen.

Furthermore, in S106, the control unit 100 also transmits, to the display apparatus 20, a control signal for causing the sound output device 28, disposed on the display where a predetermined touch operation has been performed between the inner display 22 and the outer display 23, to output the second switching sound together with the control signal for switching the display of the interface screen. As a result, on the inner display 22 or the outer display 23, the second switching sound is output from the sound output device 28 at the timing when the display of the interface screen is switched. After that, the execution of this flow is once ended.

With the above-described control flow, on each of the inner display 22 and the outer display 23, when the display is switched between two interface screens that are sequentially adjacent among the first interface screen to the fifth interface screen, the first switching sound is output from the sound output device 28. On each of the inner display 22 and the outer display 23, when the display is switched between the first interface screen and the fifth interface screen, the second switching sound is output from the sound output device 28. As a result, when the display is switched between the first interface and the fifth interface on the inner display 22 or the outer display 23, the user is able to auditorily recognize the switch.

In the present embodiment, it is not indispensable for a predetermined switching sound to be always output from the sound output device 28 when the display of the interface screen is switched on each of the inner display 22 and the outer display 23. For example, on each of the inner display 22 and the outer display 23, a predetermined switching sound may be output from the sound output device 28 only when the display is switched between the first interface screen and the fifth interface screen. In this case, on each of the inner display 22 and the outer display 23, when the display is switched between two interface screens that are sequentially adjacent among the first interface screen to the fifth interface screen, the switching sound is not output from the sound output device 28. Even when the output of the switching sound from the sound output device 28 is controlled in this way, the user is able to auditorily recognize the switching of the display between the first interface and the fifth interface on each of the inner display 22 and the outer display 23.

### Second Embodiment

### Hardware Configuration

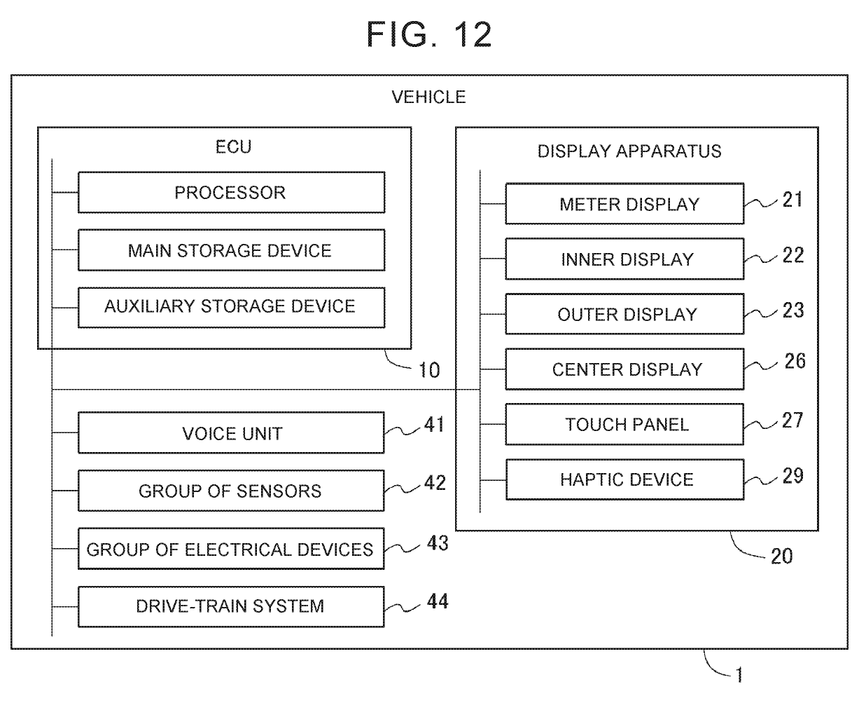

In the present embodiment, part of the configuration of the display apparatus 20 is different from that of the first embodiment. FIG. 12 is a block diagram that schematically shows an example of the hardware configuration of a system mounted on the vehicle according to the present embodiment. In the present embodiment as well, the system mounted on the vehicle 1 includes the ECU 10, the display apparatus 20, the voice unit 41, the group of sensors 42, the group of electrical devices 43, and the drive-train system 44, similar to the first embodiment. In the present embodiment, the display apparatus 20 includes a haptic device 29 instead of the sound output device 28 in the first embodiment.

The haptic device 29 is a device for outputting a haptic feedback (for example, vibration). The haptic device 29 may be configured to include a vibrator, such as an eccentric motor type or a piezoelectric type. The haptic device 29 is disposed on each of the inner display 22 and the outer display 23, similarly to the sound output device 28 in the first embodiment. The haptic device 29 is a device for outputting a predetermined haptic feedback when the display of the interface is switched on the inner display 22 or the outer display 23. The configuration of the display apparatus 20 in the system mounted on the vehicle 1 according to the present embodiment is similar to the configuration according to the first embodiment, except for the haptic device 29.

### Switching of Interface Screens

In the display apparatus 20 according to the present embodiment, two types of haptic feedbacks are selectively used as a predetermined switching haptic feedback output from the haptic device 29. Specifically, on each of the inner display 22 and the outer display 23, when the display is switched between two interface screens that are sequentially adjacent among the first interface screen to the fifth interface screen, a first switching haptic feedback is output from the haptic device 29. In other words, when the display is switched between the first interface screen and the second interface screen, between the second interface screen and the third interface screen, between the third interface screen and the fourth interface screen, or between the fourth interface screen and the fifth interface screen, the first switching haptic feedback is output from the haptic device 29. On the other hand, on each of the inner display 22 and the outer display 23, when the display is switched between the first interface screen and the fifth interface screen, a second switching haptic feedback different from the first switching haptic feedback is output from the haptic device 29. Here, the second switching haptic feedback may be, for example, a vibration having an amplitude or a frequency different from that of the first switching haptic feedback.

By using two types of haptic feedbacks as predetermined switching haptic feedbacks output from the haptic device 29, the user is able to perceptually (that is, haptically) recognize the switch when the display is switched between the first interface and the fifth interface on each of the inner display 22 and the outer display 23. Therefore, in the present embodiment as well, it becomes easy for the user to perceptually recognize whether the cycle of the five types of interface screens that can be displayed on each display has already completed one round or is still ongoing, similarly to the first embodiment. This can contribute to enabling the user to display a desired interface screen on the inner display 22 or the outer display 23.

### Control Flow

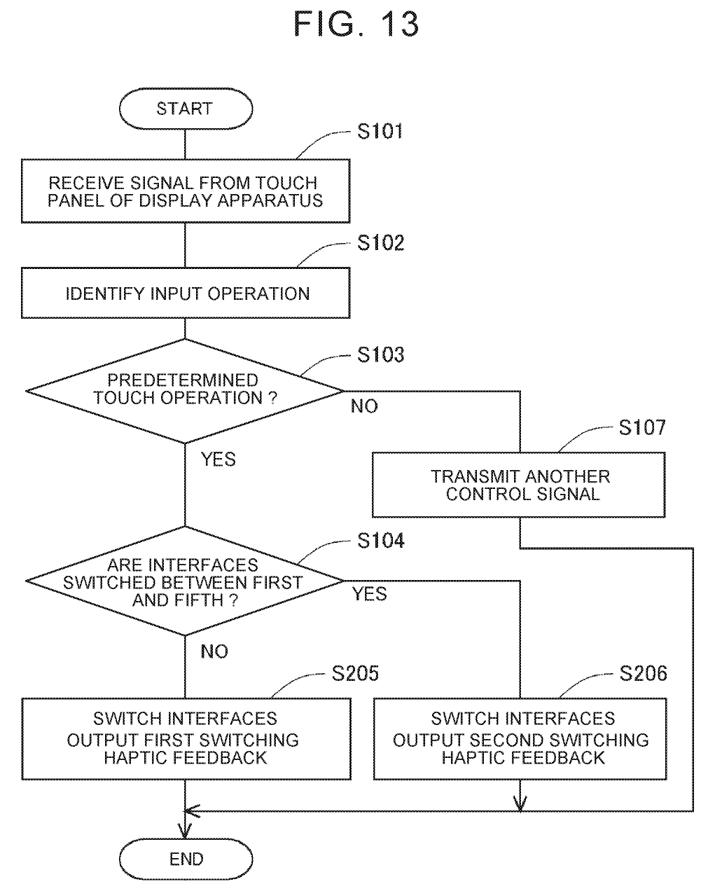

Hereinafter, the flow of the display switching control for the interface screens on each of the inner display 22 and the outer display 23 will be described with reference to FIG. 13. FIG. 13 is a flowchart that shows the flow of display switching control for the interface screens according to the present embodiment. This flow is executed by the control unit 100 of the ECU 10. The processes in steps other than S205 and S206 in the flow shown in FIG. 13 are similar to the processes in steps with the same reference signs in the flow shown in FIG. 11. For this reason, the description of the processes in steps other than S205 and S206 is omitted.

In this flow, when the determination is negative in S104, the process of S205 is subsequently executed. In S205, similarly to the process in S105 shown in FIG. 11, the control unit 100 transmits, to the display apparatus 20, a control signal for switching the display of the interface screen on the display where a predetermined touch operation has been performed between the inner display 22 and the outer display 23. As a result, on the inner display 22 or the outer display 23, the display is switched between two interface screens that are sequentially adjacent among the first interface screen to the fifth interface screen.

Furthermore, in S205, the control unit 100 also transmits, to the display apparatus 20, a control signal for causing the haptic device 29, disposed on the display where a predetermined touch operation has been performed between the inner display 22 and the outer display 23, to output the first switching haptic feedback together with the control signal for switching the display of the interface screen. As a result, on the inner display 22 or the outer display 23, the first switching haptic feedback is output from the haptic device 29 at the timing when the display of the interface screen is switched. After that, the execution of this flow is once ended.

On the other hand, when the determination is affirmative in S104, the process of S206 is subsequently executed. In S206 as well, the control unit 100 transmits, to the display apparatus 20, a control signal for switching the display of the interface screen on the display where a predetermined touch operation has been performed between the inner display 22 and the outer display 23. However, in this case, similarly to the process of S106 in the flow shown in FIG. 11, the display is switched between the first interface screen and the fifth interface screen on the inner display 22 or the outer display 23.

Furthermore, in S206, the control unit 100 also transmits, to the display apparatus 20, a control signal for causing the haptic device 29, disposed on the display where a predetermined touch operation has been performed between the inner display 22 and the outer display 23, to output the second switching haptic feedback together with the control signal for switching the display of the interface screen. As a result, on the inner display 22 or the outer display 23, the second switching haptic feedback is output from the haptic device 29 at the timing when the display of the interface screen is switched. After that, the execution of this flow is once ended.

With the above-described control flow, on each of the inner display 22 and the outer display 23, when the display is switched between two interface screens that are sequentially adjacent among the first interface screen to the fifth interface screen, the first switching haptic feedback is output from the haptic device 29. On each of the inner display 22 and the outer display 23, when the display is switched between the first interface screen and the fifth interface screen, the second switching haptic feedback is output from the haptic device 29. As a result, when the display is switched between the first interface and the fifth interface on the inner display 22 or the outer display 23, the user is able to haptically recognize the switch.

In the present embodiment, it is not indispensable for a predetermined switching haptic feedback to be always output from the haptic device 29 when the display of the interface screen is switched on each of the inner display 22 and the outer display 23. For example, on each of the inner display 22 and the outer display 23, a predetermined switching haptic feedback may be output from the haptic device 29 only when the display is switched between the first interface screen and the fifth interface screen. In this case, on each of the inner display 22 and the outer display 23, when the display is switched between two interface screens that are sequentially adjacent among the first interface screen to the fifth interface screen, a haptic feedback is not output from the haptic device 29. Even when the output of the haptic feedback from the haptic device 29 is controlled in this way, the user is able to haptically recognize the switching of the display between the first interface and the fifth interface on each of the inner display 22 and the outer display 23.

In the first embodiment and the second embodiment, an example in which five types of interface screens from the first to the fifth are sequentially switched and displayed on each of the inner display 22 and the outer display 23 has been illustrated. However, the types of interface screens displayed on each of the inner display 22 and the outer display 23 are not limited to five, and it is sufficient that there are at least three or more types. Then, when the number of types of interface screens displayed on each of the inner display 22 and the outer display 23 is n (n ≥ 3), it is sufficient that the interface screens from the first to the n^{th} are sequentially switched and displayed. On each of the inner display 22 and the outer display 23, when the display is switched between the first interface screen and the n^{th} interface screen, it is sufficient that a different switching sound or switching haptic feedback is output compared to when the display is switched between two interface screens that are sequentially adjacent and that are different from between the first interface screen and the n^{th} interface screen.

In the first embodiment and the second embodiment, a case where the display apparatus according to the disclosure is applied to the display apparatus 20 in the in-vehicle system configured as described above has been described. However, the display apparatus to which the disclosure is applied is not limited to a display apparatus that includes a pair of displays, such as the inner display 22 and the outer display 23. The display apparatus to which the disclosure is applied is not limited to a display apparatus that is a component of the in-vehicle system. For example, the display apparatus according to the disclosure may be applied to a user terminal, such as a smartphone carried by the user, or to a facility terminal installed in a facility, such as a shop.

### Other Embodiments

The above-described embodiments are only illustrative, and the disclosure can be implemented with modifications as needed without departing from the purport of the disclosure. The processes and devices described in the disclosure may be freely implemented in combination without any technical contradiction.

A process described as the one that is performed by a device may be shared and performed by multiple devices. Alternatively, processes described as the ones that are respectively performed by different devices may be performed by a single device. In a computer system, what hardware configuration (server configuration) implements functions may be flexibly changed.

The disclosure may also be implemented as follows. A computer is supplied with a computer program having the functions described in the above-described embodiments, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (CD-ROM, DVD disc, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. A display apparatus comprising a display unit with a touch panel, wherein:
the display unit is configured to sequentially switch and display a first interface to an n^{th} interface in response to a predetermined touch operation performed by a user, n being an integer equal to or greater than three; and
when a display is switched between the first interface and the n^{th} interface on the display unit, feedback is output to the user perceptually different from when the display is switched between interfaces other than between the first interface and the n^{th} interface.

2. The display apparatus according to claim 1, further comprising a sound output device, wherein the feedback is a sound output from the sound output device.

3. The display apparatus according to claim 2, wherein a predetermined sound is output from the sound output device when a display is switched between the first interface and the n^{th} interface on the display unit, and a sound is not output from the sound output device when a display is switched between interfaces other than between the first interface and the n^{th} interface on the display unit.

4. The display apparatus according to claim 1, further comprising a haptic device, wherein the feedback is a haptic feedback output by the haptic device.

5. The display apparatus according to claim 4, wherein:
a predetermined haptic feedback is output by the haptic device when a display is switched between the first interface and the n^{th} interface on the display unit; and
a haptic feedback is not output by the haptic device when a display is switched between interfaces other than between the first interface and the n^{th} interface on the display unit.

6. The display apparatus according to claim 1, wherein the predetermined touch operation is a scroll or swipe in a horizontal direction or a vertical direction.

7. An in-vehicle system comprising:
a display apparatus that includes a plurality of display units including at least a pair of display units; and
an information processing apparatus configured to control the display apparatus, wherein
the pair of display units is respectively disposed on both sides of a steering wheel while projecting toward a rear side of a vehicle beyond a meter unit disposed in front of a driver seat in a vehicle cabin and directly ahead of the steering wheel;
each of the pair of display units has a touch panel; and
the information processing apparatus includes a processor configured to
on each of the pair of display units, sequentially switch and display a first interface to an n^{th} interface in response to a predetermined touch operation performed by a user, n being an integer equal to or greater than three, and
when a display is switched between the first interface and the n^{th} interface on each of the pair of display units, output, to the user, feedback perceptually different from when the display is switched between interfaces other than between the first interface and the n^{th} interface on each of the pair of display units.

8. The in-vehicle system according to claim 7, wherein:
the display apparatus further includes a sound output device; and
the processor is configured to cause the sound output device to output a sound as the feedback.

9. The in-vehicle system according to claim 8, wherein the processor is configured to cause the sound output device to output a predetermined sound when a display is switched between the first interface and the n^{th} interface on each of the pair of display units and not to cause the sound output device to output a sound when a display is switched between interfaces other than between the first interface and the n^{th} interface on each of the pair of display units.

10. The in-vehicle system according to claim 7, wherein:
the display apparatus further includes a haptic device; and
the processor is configured to cause the haptic device to output a haptic feedback as the feedback.

11. The in-vehicle system according to claim 10, wherein the processor is configured to cause the haptic device to output a predetermined haptic feedback when a display is switched between the first interface and the n^{th} interface on each of the pair of display units and not to cause the haptic device to output a haptic feedback when a display is switched between interfaces other than between the first interface and the n^{th} interface on each of the pair of display units.

12. The in-vehicle system according to claim 7, wherein the predetermined touch operation is a scroll or swipe in a horizontal direction or a vertical direction.

13. A vehicle comprising the in-vehicle system according to claim 7.
